(19) United States
(12) Patent Application Publication
(10) Pub. No.: US 2013/0278614 A1
(43) Pub. Date: Oct. 24, 2013

(54) Information Handling System Display Adaptive Self-Refresh

(71) Applicants: Andrew Sultenfuss, Leander, TX (US); Stefan Peana, San Diego, CA (US)

(72) Inventors: Andrew Sultenfuss, Leander, TX (US); Stefan Peana, San Diego, CA (US)

(21) Appl. No.: 13/449,557

(22) Filed: Apr. 18, 2012

(51) Int. Cl. G06F 13/14

(52) U.S. Cl. 345/520

(57) ABSTRACT

Information presented as images at a display are provided by a panel self-refresh module of the display instead of a graphics system, with the panel self-refresh module using a reduced refresh rate of the image to reduce power consumption. During a panel self-refresh mode, brightness of an image presented at the display is managed locally at the display to support power down of a graphics system interfaced with the display.

### BACKGROUND OF THE INVENTION

1. Field of the Invention

The present invention relates in general to the field of information handling system displays, and more particularly to an information handling system display adaptive self-refresh.

2. Description of the Related Art

As the value and use of information continues to increase, individuals and businesses seek additional ways to process and store information. One option available to users is information handling systems. An information handling system generally processes, compiles, stores, and/or communicates information or data for business, personal, or other purposes thereby allowing users to take advantage of the value of the information. Because technology and information handling needs and requirements vary between different users or applications, information handling systems may also vary regarding what information is handled, how the information is handled, how much information is processed, stored, or communicated, and how quickly and efficiently the information may be processed, stored, or communicated. The variations in information handling systems allow for information handling systems to be general or configured for a specific user or specific use such as financial transaction processing, airline reservations, enterprise data storage, or global communications. In addition, information handling systems may include a variety of hardware and software components that may be configured to process, store, and communicate information and may include one or more computer systems, data storage systems, and networking systems.

Information handling systems generally generate information for presentation at a display by running applications on a main processor, such as central processing unit (CPU). The main processor typically outputs visual information to a graphics system for rendering of visual images. In some instances, a basic graphics system is included with a chipset for rendering visual images with basic rendering tools; in other instances, a graphics processor unit (GPU) included in a chipset or a separate daughter card applies advanced rendering tools to provide an improved display response. For example, basic information processing functions, such as e-mail, web browsing, and word processing, typically do not use substantial graphics system processing resources to present visual images; in contrast, more advanced information processing functions, such as gaming, drawing, and audiovisual playing, typically rely on GPU processing resources to present visual images at a display with adequate clarity and responsiveness. Generally, the application running on the main processor shifts visual image rendering tasks to the graphics system, which has specialized hardware for performing rendering. Shifting rendering tasks to the graphics system provides greater processing resources at the main processor for running the application and provides greater responsiveness for images presented at the display.

One difficulty with the use of a graphics system is that the additional processing resources for rendering visual images consume additional power, even when minimal graphics processing is needed to support an application running on a main processor. For example, when an end user has an information handling system powered up but not in active use, the information handling system often continues to present the same visual images at its display, such as a web page or screen saver. When an information handling system has a powerful graphics system, the presentation of a visual image can consume unnecessary power by the graphics system to continue to feed the display a rendered image where minimal if any processing is performed by the graphics system to render the image. One solution offered by the DISPLAYPORT standard version 1.3 is panel self-refresh (PSR), which supports presentation of a rendered image by a buffer at a display so that a graphics system can reduce power consumption when a constant visual image is presented using the buffer at the display. The display buffer stores the rendered image and refreshes the image at the display so that the graphics system does not have to render and communicate the image to the display. Although panel self-refresh with a display buffer reduces power consumption by a graphics system by reducing processing associated with the rendering of a constant image, image quality can suffer and some power consumption by the graphics system and the display continues.

### SUMMARY OF THE INVENTION

Therefore a need has arisen for a system and method which supports presentation of an image at a display with reduced power consumption.

In accordance with the present invention, a system and method are provided which substantially reduce the disadvantages and problems associated with previous methods and systems for presenting an image at a display with reduced power consumption at the display and/or a host information handling system. A first refresh rate for presenting visual image information from a graphics system at a display is reduced to a second refresh rate when the display enters a panel self-refresh mode to present the visual image information from local storage of the display. During a panel self-refresh mode, the graphics system powers off to save energy and backlight control at the display is managed locally at the display while the graphics system is powered down.

More specifically, an information handling system executes applications on a processor to generate visual information for presentation at a display. A graphics system processes the visual information to generate visual image information to communicate to the display, such as pixel values for generating a visual image with pixels of the display. The visual image information is communicated to the display through a cable or other medium, such as wireless link, and saved in a buffer memory local to the display. Upon detection of a panel self-refresh indicator, such as power down of the graphics system or presentation of a constant image at the display for a predetermined time, the display enters a panel self-refresh mode by refreshing visual image information from the buffer to the pixels at a second refresh rate that is less than the first refresh rate. The reduced refresh rate reduces power consumption while persistence of liquid crystals in a display panel retain presentation of the image at the display. The second refresh rate can vary over time and can vary with the characteristics of the image presented at the display. During power down of the graphics system, the display generates a local pulse width modulation signal to replace that of the graphics system for managing backlight illumination. In one embodiment, the display emulates backlight illumination expected from the graphics system, such as dimming and powering off illumination after predetermined idle periods.

The present invention provides a number of important technical advantages. One example of an important technical advantage is that panel self-refresh for an image at a display uses less power with local control of backlight operations and modified refresh rates. When panel self-refresh takes control by presenting an image from a buffer of the display, the display controller takes control of backlight operations so that the image is presented at the display without communications between the graphics system and the display, thus reducing power consumption of the graphics system and the display communication interface. The controller mimics backlight control that would otherwise be provided to the display from the graphics system so that panel self-refresh provides the display image without impact to the end user experience. Power consumption at the display is further reduced by adjusting panel refresh rates to take advantage of image persistence at the display so that less frequent image refreshes are performed. Reduced power consumption provides reduced operating expenses and improved battery life for mobile devices, such as portable information handling systems.

### BRIEF DESCRIPTION OF THE DRAWINGS

The present invention may be better understood, and its numerous objects, features and advantages made apparent to those skilled in the art by referencing the accompanying drawings. The use of the same reference number throughout the several figures designates a like or similar element.

FIG. 1 depicts a block diagram of an information handling system interfaced with a display having panel self-refresh at variable refresh rates;

FIG. 2 depicts a block diagram of a display having panel self-refresh supported at variable refresh rates; and

FIG. 3 depicts a flow diagram of a process for setting a refresh rate of a display that presents visual images from a graphics system for a panel self-refresh module.

### DETAILED DESCRIPTION

Information presented by an information handling system at a display has a first refresh rate associated with information sent from a graphics system of the information handling system and a second refresh rate associated with panel self-refresh of visual image information stored locally at the display. For purposes of this disclosure, an information handling system may include any instrumentality or aggregate of instrumentalities operable to compute, classify, process, transmit, receive, retrieve, originate, switch, store, display, manifest, detect, record, reproduce, handle, or utilize any form of information, intelligence, or data for business, scientific, control, or other purposes. For example, an information handling system may be a personal computer, a network storage device, or any other suitable device and may vary in size, shape, performance, functionality, and price. The information handling system may include random access memory (RAM), one or more processing resources such as a central processing unit (CPU) or hardware or software control logic, ROM, and/or other types of nonvolatile memory. Additional components of the information handling system may include one or more disk drives, one or more network ports for communicating with external devices as well as various input and output (I/O) devices, such as a keyboard, a mouse, and a video display. The information handling system may also include one or more buses operable to transmit communications between the various hardware components.

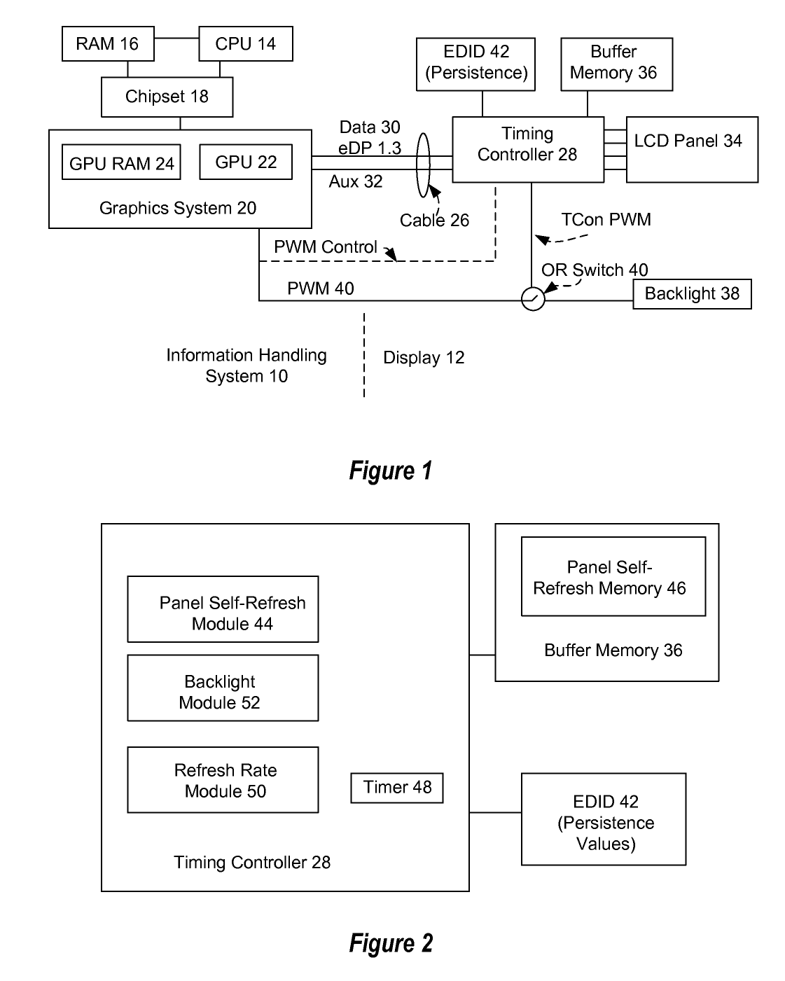

Referring now to FIG. 1, a block diagram depicts an information handling system 10 interfaced with a display 12 having panel self-refresh at variable refresh rates. Information handling system 10 is built from plural components that cooperate to process information for presentation at display 12. For example, a central processing unit (CPU) 14 executes applications stored in random access memory (RAM) 16 to generate visual information for presentation to an end user. The visual information is communicated under coordination of a chipset 18 having firmware, such as a BIOS, to a graphics system 20, which processes the visual information to generate visual image information for communication to display 12. For example, graphics system 20 includes a graphics processor unit (GPU) 22 and graphics memory 24, which cooperate to execute instructions that translate visual information generated by CPU 14 into visual image information of pixel values that define colors for pixels at display 12. The visual image information is communicated through a cable 26, such as a DisplayPort cable, to display 12 where the pixel values are applied to present a visual image at display 12.

Display 12 has a timing controller 28 that receives visual image information from data links 30 of cable 26 and supports bi-directional communication of management information with graphics system 20 through an auxiliary link 32. Timing controller 28 communicates visual image information pixel values to appropriate pixels of a display panel 34 so that a visual image is presented at display panel 34. The image is drawn on display panel 34 at a refresh rate, which defines the frequency with which timing controller 28 establishes pixel values. Timing controller 28 stores visual image information in a buffer memory 36 to aid in setting pixel values by storing the pixel values that are provided from graphics system 20 through cable 26 until the time arrives for timing controller 28 to draw the pixel values to pixels of display panel 34. A backlight 38 provides illumination from behind display panel 34 to illuminate the image drawn by the pixel values. Brightness levels for backlight 38 are provided from graphics system 20 with a pulse width modulation (PWM) line 40 that carries a PWM signal. During normal operations, the refresh rate used by timing controller 28 is typically defined by the manufacturer of display panel 34 so that a visual image has adequate clarity and responsiveness. Display panel 34 applies pixel values to liquid crystals with an electrical signal that adjusts how the liquid crystals allow light to pass through. The electrical signals are set to overcome persistence of the liquid crystals, which tend to “persist” at a setting unless an electrical signal of sufficient strength is applied.

In order to reduce power consumption of information handling system 10, graphics system 20 and timing controller 28 include logic, such as firmware instructions, to power down graphics system 20 when a constant visual image is presented at display 12 and to present the image from buffer memory 36 of display 12. For example, when an end user is not actively using information handling system 10 a constant visual image presented at display 12 might include the presentation prepared by one or more applications running on CPU 14, such as an e-mail interface, a web browser interface and a word processor interface each presented in a window at display 12. As another example, a screen saver replaces the presentation of application visual images after the end user fails to interact with the information handling system for a time setting. In some instances, a constant visual image can include motion, such as a spinning wheel of a screen saver, where the motion has a repeated pattern or a random pattern that timing controller 28 can create. To reduce power consumption, graphics system 20 powers down and timing controller 28 employs panel self-refresh to present visual images at display 12 with visual image information stored in buffer memory 36. A complete power down of graphics system 20 removes the backlight PWM signal from line 40 so that timing controller 28 takes over backlight control through an OR circuit 40. Thus, power consumption is reduced by powering down graphics system 20 and the interface that supports communication through cable 26 while presentation of a constant visual image is supported locally at display 12 with timing controller 28 and buffer memory 36. Timing controller 28 exits the panel self-refresh mode when graphics system 20 initiates communication of signals through cable 26 so that visual image information provided by graphics system 20 are again presented at display 12.

In addition to saving power consumption of graphics system 20 by entering a panel self-refresh mode, timing controller 28 saves power at display 12 by using a reduced refresh rate for presenting visual image information in the panel self-refresh mode relative to the refresh rate used for normal operations that present visual image information from graphics system 20. Management information stored in EDID memory 42 includes persistence information for display panel 34, which timing controller 28 applies to determine a refresh rate for use in the panel self-refresh mode of operations. When a constant image presented at display panel 34 results in constant pixel values, such as where no motion is associated with an image, then the persistence of liquid crystals in display panel 34 allows a less frequent refresh rate to maintain the constant image, thus reducing power consumption of timing controller 28 and the circuitry within display 12 that sets pixel values. In one embodiment, when timing controller 28 initiates a panel self-refresh mode, the circuitry in display 12 alters the electronic currents used to set pixel values for liquid crystals so that persistence of pixels is enhanced to allow a further reduced refresh rate, such as by reducing the voltage or current applied to liquid crystals of a display panel when in the panel self-refresh mode. In one embodiment, panel self-refresh can initiate locally at display 12 upon detection of presentation of a constant image even if graphics system 20 remains active so that power consumption at display 12 is reduced on a frame-by-frame or even partial frame basis with reduced refresh rate frequency.

Referring now to FIG. 2, a block diagram depicts a display having panel self-refresh supported at variable refresh rates. In the example embodiment of FIG. 2, logical modules execute on timing controller 28 or, alternatively, on other processing resources, such as hardware or firmware instructions loaded on an ASIC. A panel self-refresh module manages entry into and exit from a panel self-refresh mode in which a visual image is locally generated for presentation at display panel 34 from visual image information stored in a panel self-refresh buffer memory 46 defined in display buffer memory 36. For example, panel self-refresh module 44 detects a loss of signal from graphics system 20 or a constant image provided from graphics system 20 for a predetermined time as measured by a local timer 48, and in response initiates panel self-refresh. Panel self-refresh module 44 alters the refresh rate at display 20 to a lower rate for use during panel self-refresh mode. In one embodiment, the refresh rate used during a panel self-refresh mode varies over time as set by a refresh rate module 50. Refresh rate module 50 retrieves persistence characteristics from EDID 42 and applies the persistence characteristics to determine a refresh rate for use with visual images presented during the panel self-refresh mode. For example, refresh rate module 50 determines a refresh rate for use by panel self-refresh module 44 based upon the amount of time that a panel self-refresh mode is commanded and the color, brightness and motion of the visual image presented by panel self-refresh. In one example embodiment, a dimly lit black and white word processing visual image will have relatively few panel refreshes compared with a colorful family picture screen saver or wallpaper visual image. In another example embodiment, a dimly lit black and white word processing visual image will have a decreasing refresh rate over time as the display remains in the panel self-refresh mode. In yet another alternative embodiment, refresh rate module 50 alters the electrical signals applied by display panel 34 to liquid crystals at pixels so that a less frequent refresh rate will maintain an existing image.

A backlight module 52 initiates control of backlight illumination in the event that backlight PWM control signals from graphics system 20 end, such as by a power down of graphics system 20. Backlight module emulates backlight control expected from graphics system 20, such as by dimming and/or powering down backlight 38 after defined inactivity time periods. Backlight module 52 returns control of backlight 38 to graphics system 20 when a PWM or timing signal is detected, such as at power up of graphics system 20.

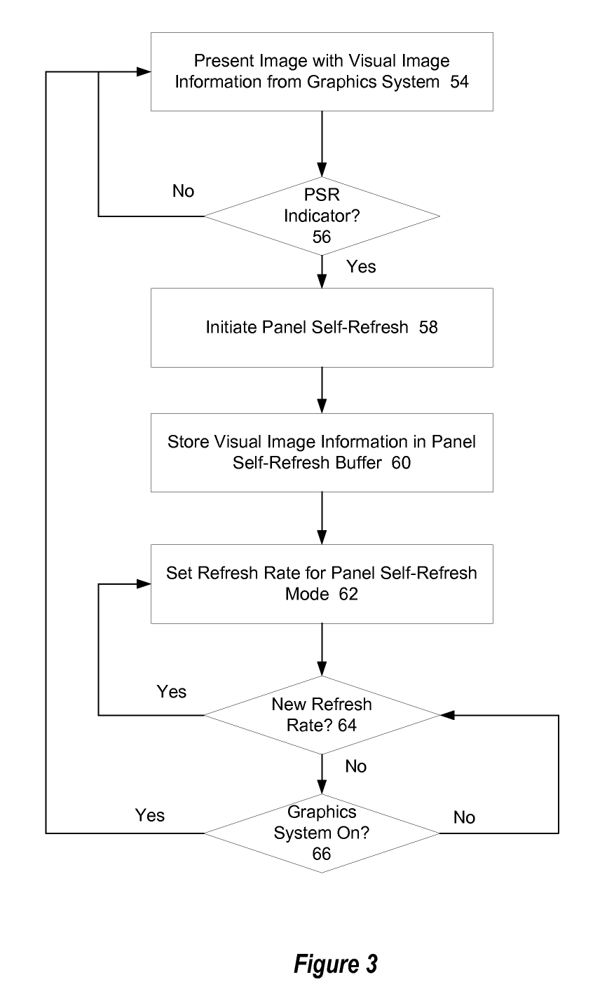

Referring now to FIG. 3, a flow diagram depicts a process for setting a refresh rate of a display that presents visual images from a graphics system for a panel self-refresh module. The process begins at step 54 with presentation of a visual image at a display by communicating visual image information from a graphics system to the display. The visual image information is sent by a timing controller to display pixels at a first refresh rate. At step 56, a panel self-refresh indicator is detected at the display, such as by detecting power down of the graphics system or a constant image provided from the graphics system for a predetermined time period. If no panel self-refresh indicator is detected, the process returns to step 54 to continue presenting visual information provided from the graphics system. At step 58, in response to the panel self-refresh indicator, a panel self-refresh mode is initiated at the display to present a visual image from visual image information stored locally in a panel self-refresh buffer memory. At step 60, the visual image information from the graphics system is stored in a buffer memory for use in a panel self-refresh mode. The panel self-refresh buffer memory is filled with visual image information provided from the graphics system when panel self-refresh mode is entered so that use of the panel self-refresh buffer does not interfere with or slow normal display operations. In an alternative embodiment, the panel self-refresh buffer may be filled from the graphics system as the visual image information changes over time or may be a shared buffer space that converts to use for panel self-refresh when needed. At step 62, a second refresh rate is set for use during the panel self-refresh mode so that fewer panel refreshes are used to present the visual image, thus reducing power consumption. At step 64, a determination is made of whether a lower or higher refresh rate should be used for the panel self-refresh. If so, the process returns to step 62 to re-set the refresh rate. If not, the process continues to step 66 to determine whether to return presentation of an image at the display back to the graphics system, such as when a timing signal is provided from the graphics system or the visual image of the graphics system changes. If so, the process returns to step 54 to present the visual image provided by the graphics system. If not, the process returns to step 60 to continue with the panel self-refresh mode.

Although the present invention has been described in detail, it should be understood that various changes, substitutions and alterations can be made hereto without departing from the spirit and scope of the invention as defined by the appended claims.

What is claimed is:

1. An information handling system comprising:
a processor operable to execute an application to generate visual information;
a graphics system interfaced with processor and operable render the visual information as visual image information for presentation of an image at a display;
a display interfaced with the graphics system and operable to apply the visual image information to present the image at a first refresh rate; and
a panel self-refresh module integrated with the display and having a memory, the panel self-refresh module operable to store the visual image information in the memory and to apply the visual image information at a second refresh rate to present the image at the display instead of visual image information provided from the graphics system, the second refresh rate having a reduced frequency relative to the first refresh rate.

2. The information handling system of claim 1 wherein the panel self-refresh module stores persistence information associated with the display and applies the persistence information to one or more predetermined factors to determine the second refresh rate.

3. The information handling system of claim 2 wherein the predetermined factors comprise the amount of time that the panel self-refresh module applies visual information from the memory instead of the graphics system.

4. The information handling system of claim 2 wherein the predetermined factors comprise a brightness setting of a backlight of the display.

5. The information handling system of claim wherein the panel self-refresh module comprises firmware instructions stored in memory of the display and executed by a controller of the display.

6. The information handling system of claim 1 wherein the panel self-refresh module comprises an application specific integrated circuit.

7. The information handling system of claim 1 wherein the panel self-refresh module is further operable to control brightness of a display backlight instead of control from the graphics system.

8. The information handling system of claim 7 wherein the panel self-refresh module controls the display backlight to mimic automated display power down performed by the graphics system.

9. The information handling system of claim 8 wherein the automated display power down comprises powering off the backlight after a predetermined inactivity time.

10. A method for presenting information at a display, the method comprising:
communicating visual image information from a graphics system to a display;
presenting the visual image information as visual images at the display with a first refresh rate;
storing the visual image information in memory of the display; and
in response to a predetermined condition, presenting the visual image at the display with the visual image information stored in the memory instead of visual image information communicated from the graphics system, the visual image information presented from the memory with a second refresh rate having a reduced frequency relative to the first refresh rate.

11. The method of claim 10 further comprising:
retrieving a persistence value from the display; and
analyzing one or more predetermined factors with the persistence value to determine the second refresh rate.

12. The method of claim 11 wherein the predetermined factors comprise a brightness setting of a backlight of the display.

13. The method of claim 11 wherein the predetermined factors comprise a color value associated with the visual image information.

14. The method of claim 11 wherein the predetermined factors comprise a length of time associated with the presenting the visual image information with the second refresh rate.

15. The method of claim 11 wherein the predetermined factors comprise motion associated with the visual image information.

16. The method of claim 10 wherein the predetermined condition comprises a lack of communication of visual image information from the graphics system.

17. The method of claim 16 further comprising:
in response to the predetermined condition, illuminating a backlight of the display with a brightness determined at the display instead of the graphics system.

18. A system for presenting information at a display, the system comprising:
memory integrated in the display and operable to store visual image information;
a controller integrated in the display and operable to apply visual image information to present information at the display with a first or second refresh rate; and
a panel self-refresh module operable to detect a predetermined condition and at the display with the second refresh rate instead of the first refresh rate.

19. The system of claim 18 wherein the predetermined condition comprises presentation of a constant image at the display.

20. The system of claim 18 wherein the predetermined condition comprises removal of communication of visual image information from a graphics system to the display.
